(19) United States
(12) Patent Application Publication
(10) Pub. No.: US 2008/0175985 A1
(43) Pub. Date: Jul. 24, 2008

(54) Method of Preparing Stable Oxide Ceramic Precursor Sol-Gel Solutions Based on Lead, Titanium, Zirconium and Lanthanide(s) and Method of Preparing Said Ceramic

(75) Inventors: Philippe Belleville, Rue Charles Gille Tours (FR); Philippe Boy, Joue les Tours (FR); Yves Montouillout, Le Bardon (FR)

Correspondence Address: HUTCHISON LAW GROUP PLLC, PO BOX 31686, RALEIGH, NC, 27612, US

(73) Assignee: Commissariat A L'Energie Atomique, Paris (FR)

(21) Appl. No.: 11/883,145

(22) PCT Filed: Jan. 27, 2006
(86) PCT No.: PCT/FR06/50066

§ 371 Date: Feb. 26, 2008

(30) Foreign Application Priority Data
Jan. 27, 2005 (FR) 0550234

(51) Int. Cl. B05D 5/12; B01J 13/00

(52) U.S. Cl. 427/126.3; 516/98

(57) ABSTRACT

The invention relates to a method of preparing a stable sol-gel solution as precursor of an oxide ceramic based on lead, titanium, zirconium and one or more lanthanides, comprising, in succession, the following steps:
a) a sol-gel solution is prepared by bringing a lead-containing molecular precursor, a titanium-containing molecular precursor, a zirconium-containing molecular precursor and a lanthanide-metal-containing molecular precursor into contact with a medium comprising a diol solvent and optionally an aliphatic monoalcohol;
b) the solution obtained in step a) is left to stand for a sufficient time needed to obtain a solution having an approximately constant viscosity; and
c) the solution obtained in step b) is diluted to a predetermined amount with a diol solvent identical to that of step a) or a solvent miscible with this solvent.

Application to the preparation of an oxide ceramic material comprising lead, a lanthanide metal, titanium and zirconium.

### TECHNICAL FIELD

The subject of the present invention is a method of preparing a stable sol-gel solution as precursor of an oxide ceramic based on lead, titanium, zirconium and a lanthanide metal.

The invention also relates to the sol-gel solution that can be obtained by this method.

The subject of the present invention is also a method of preparing a material made of an oxide ceramic based on lead, titanium, zirconium and a lanthanide metal from such a stable sol-gel solution.

Finally, the invention relates to a material that can be obtained by this method.

Such materials have the feature of exhibiting a high dielectric constant and also piezoelectric and ferroelectric properties, said materials therefore proving to be particularly effective in many electronic applications, such as in actuators, in sensors, in nonvolatile memories and in capacitors.

### PRIOR ART

This type of ceramic may be obtained by vapor phase, plasma phase, solid phase or liquid phase processes.

For processes taking place in the vapor phase, the process most commonly used is evaporation, in which the ceramic to be deposited is placed in a crucible heated to a temperature such that vapors form and these condense in the form of a coating or layer on a cooled substrate. Mention may also be made of processes for synthesizing ceramics by CVD (chemical vapor deposition).

For processes involving a plasma phase, mention may be made of cathode sputtering. In this technique, the ceramic material to be deposited is bombarded with ions generated by a plasma. The kinetic energy of the plasma ions is transferred to the atoms of the material to be deposited, which are projected with a high velocity onto the substrate to be coated, being deposited on the latter in the form of a coating or layer. The drawback of these processes taking place in a plasma phase lies in the fact that they are very expensive.

For processes taking place in the solid phase, mention may be made of the sintering of organometallic compounds followed by annealing.

It is possible to mention a technique involving a solid/liquid dispersion, consisting in mixing a ceramic powder with an organic solvent, in depositing this dispersion in the form of a layer on a substrate, and in heat treating this layer. Another technique consists in sintering a ceramic powder on a substrate with addition of adhesive. For these two techniques, the thickness of the layers cannot be precisely controlled.

Solid-phase processes require the use of very high temperatures (generally above 1000° C.) and of a refractory apparatus.

One way of circumventing the drawbacks of the abovementioned processes is one that takes place only in a liquid phase, which is none other than the sol-gel process.

The sol-gel process consists, in a first step, in preparing a solution containing precursors of these oxide ceramics in the molecular state (organometallic compounds and metal salts, which include the metallic elements that will be incorporated into the ceramic), thus forming a sol (also called a sol-gel solution). In a second step, this sol-gel solution is deposited, in the form of a film, on a substrate. Upon contact with the ambient moisture, the precursors hydrolyze and condense to form an oxide network trapping the solvent, thereby resulting in a gel. The gel layer forming a film is then heat treated so as to form a ceramic film.

The sol-gel process has many advantages over the abovementioned processes:
it makes it possible to produce coatings on complex surfaces of diverse size and without requiring heavy equipment;
it makes it possible to obtain surface coatings that are homogeneous in terms of composition and thickness; and
it is possible, owing to the mixing of the species taking place on a molecular scale, for complex oxides containing for example three or more elements to be easily produced by this process.

Consequently, the sol-gel process for preparing an oxide ceramic based on a metal lanthanide, lead, titanium and zirconium has been the subject of many publications in the prior art.

Thus, Simoes et al. in Thin Solid Films 384 (2001), 132-137 [1] describe a method of preparing a sol-gel solution as precursor of such a ceramic by dissolving molecular precursors of the metallic elements constituting it (namely zirconium n-propoxide, titanium isopropoxide, lanthanum carbonate and lead acetate, respectively) in ethylene glycol and citric acid. After dissolving these compounds, the authors add water to the solution, so as to adjust the viscosity. The major drawback of this method lies in the use of water, which contributes to making the solution unstable and dictates that the solution be used almost instantly after preparation.

Es-Souni et al. in Thin Solid Films 389 (2001), 99-107 [2] describe a method of preparing a sol-gel solution as precursor of a ceramic based on lanthanum, lead, titanium and zirconium, comprising the dissolution of molecular precursors (namely lead acetate, lanthanum nitrate, tetrapropylzirconate and tetraisopropylorthotitanate, respectively) in methoxyethanol followed by the addition of acetylacetone and acetic acid to the solution obtained previously. This method has the drawback of using as dissolution solvent methoxyethanol, which is a highly toxic solvent and industrially prohibited, thereby excluding the solutions obtained using this method from possible industrial and commercial exploitation. In addition, the solutions obtained according to this method do not have long-term stability, namely a viscosity that remains stable for a time of at least one year.

Patent application EP 0 564 866 [3] describes a method of preparing sol-gel solutions as precursors of such an oxide ceramic by dissolving appropriate molecular precursors in methoxyethanol. This method cannot be used on an industrial scale for the abovementioned reasons.

Kurchania et al. in Journal of Materials Science 33 (1998), 659-667 [4] describe the preparation of a sol-gel solution as defined above, comprising the following steps:
a step of preparing a first solution by dissolving lead acetate and lanthanum acetate in 1,3-propane diol;
a step of preparing a second solution by mixing a solution of zirconium n-propoxide in acetylacetone with a solution of titanium diisopropoxide bisacetylacetonate in 1,3-propane diol; and
a step of mixing the first and second solutions, followed by a step of diluting the mixture obtained with propanol.

It is described that the sol-gel solution obtained by this method is stable for a maximum time of four months. However this time is insufficient for commercial exploitation of these solutions.

Finally, U.S. Pat. Nos. 5,028,445 [5] and 5,116,643 [6] describe the preparation of sol-gel solutions consisting in dissolving lanthanum, lead, titanium and zirconium precursors in different solvents and then, after mixing the various solutions prepared, in adding water to the resulting mixture. However, the drawback of these methods is the use of water, which contributes to making the resulting sol-gel solutions unstable in the short term, that is to say they are unstable after a few weeks.

Thus, the methods of the prior art all have one or more of the following drawbacks:
they employ toxic solvents, which cannot be used in the industry; and
they result in sol-gel solutions that are not stable in the long term, namely stable over a time of one year or more.

The object of the invention is therefore, among others, to overcome the drawbacks of the prior art cited above and to provide a method of preparing a stable sol-gel solution as precursor of an oxide ceramic based on lead, titanium, zirconium and a lanthanide metal.

The term “stable sol-gel solution” is understood within the context of the invention to mean a solution whose viscosity remains substantially the same, especially after one year of aging, or even after a longer period.

The object of the invention is also to provide a method of preparing oxide ceramic materials from said sol-gel solution, which method is, among other things, repeatable and reproducible and of short duration, so as to be applicable on an industrial scale.

This method must in particular allow the production of materials having high dielectric constants of around 800-950 for very small film thicknesses of around 150 to 220 nm.

The term “repeatability” is understood according to the invention to mean a method of preparing materials having electrical properties, among other properties, that do not vary when said materials are prepared from the same sol-gel solution at various stages of ageing of said solution.

The term “reproducibility” is understood according to the invention to mean a method of preparing materials whose electrical properties, among other properties, do not vary when said materials are prepared from various sol-gel solutions produced by complying with the same operating conditions.

### SUMMARY OF THE INVENTION

These objects are achieved according to the invention by a method of preparing a stable sol-gel solution as precursor of an oxide ceramic based on lead, titanium, zirconium and a lanthanide metal, comprising in succession the following steps:
a) a sol-gel solution is prepared by bringing a lead-containing molecular precursor, a titanium-containing molecular precursor, a zirconium-containing molecular precursor and a lanthanide-metal-containing molecular precursor into contact with a medium comprising a diol solvent and optionally an aliphatic monoalcohol;
b) the solution obtained in step a) is left to stand for a sufficient time needed to obtain a solution having an approximately constant viscosity; and
c) the solution obtained in step b) is diluted to a predetermined amount with a diol solvent identical to that of step a) or a solvent miscible with the diol solvent used in step a).

According to the invention, the term “miscible solvent” is understood to mean a solvent that can be mixed with the diol solvent to form a homogeneous mixture, and to do so in all proportions at room temperature, that is to say at a temperature of the surrounding atmosphere of generally between 20 and 25° C.

The method of the invention advantageously makes it possible to obtain a stable sol-gel solution, thanks to the following features:
it employs a diol solvent which, apart from acting as agent for dissolving the molecular precursors, also acts as an agent for stabilizing the solution obtained;
it employs what is called a maturing step (step b), which contributes to stabilizing the sol-gel solution; and
the dilution final step makes it possible, in addition to its role of adjusting the viscosity of the sol-gel solution, to freeze the viscosity of said solution, thus contributing to the formation of a sol-gel solution of very long-term stability (of the order of a year or more).

Thus, the method of the invention comprises, in a first step, the preparation of a sol-gel solution by bringing a lead-containing molecular precursor, a titanium-containing molecular precursor, a zirconium-containing molecular precursor and a lanthanide-metal-containing molecular precursor into contact with an organic medium comprising a diol solvent and optionally an aliphatic monoalcohol.

The lead-containing molecular precursor may be chosen from inorganic lead salts and organometallic lead compounds. As examples of inorganic lead salts, mention may be made of lead chloride and lead nitrate. As examples of organometallic lead compounds, mention may be made of lead acetate and lead alkoxides.

The lanthanide-metal-containing molecular precursor may be a lanthanum-containing molecular precursor, which may be in the form of an organometallic lanthanum compound, such as lanthanum acetate, or an inorganic lanthanum salt, such as lanthanum nitrate or lanthanum chloride.

Finally, the titanium-containing and zirconium-containing molecular precursors may be inorganic titanium salts and inorganic zirconium salts or organometallic titanium compounds and organometallic zirconium compounds, such as alkoxides like titanium isopropoxide and zirconium n-propoxide, respectively.

The precursors as mentioned above are brought into contact with a medium comprising a diol solvent and optionally an aliphatic monoalcohol. The diol solvent used in step a) and optionally step c) may be an alkylene glycol having a number of carbon atoms ranging from 2 to 5. This type of solvent contributes to making it easier to dissolve the precursors and, in addition, acts as agent for stabilizing the sol-gel solution. Preferably, the diol solvent used is ethylene glycol.

In addition to the diol solvent, the medium may also contain an aliphatic monoalcohol, possibly containing, for example, 1 to 6 carbon atoms. As an example of an aliphatic monoalcohol, mention may be made of n-propanol.

According to the invention, the lanthanide metal may be chosen from La, Ce, Pr, Nd, Pm, Sm, Eu, Gd, Tb, Dy, Ho, Er, Tm, Yb and Lu. Preferably, the lanthanide metal is lanthanum.

Thus, the method of the invention is particularly suitable for preparing sol-gel solutions as precursors of oxide ceramics satisfying the following formula:

Pb_{1-y}La_{y}(Zr₁₋ₓTiₓ)O₃

in which 0<y≦0.2 and 0<x≦0.9.

The contacting of the precursors defined above with a medium as defined above may be carried out in various ways, the essential point being that, after this step, a sol-gel solution is obtained in which the lead-containing, titanium-containing, zirconium-containing and lanthanide-metal-containing molecular precursors are dissolved in the medium.

According to one particular embodiment of the invention, when the lanthanide metal is lanthanum, step a) comprises:
the preparation of a first solution by dissolving a lead-containing molecular precursor and a lanthanum-containing molecular precursor in an organic medium comprising a diol solvent such as ethylene glycol;
the preparation of a second solution by dissolving a titanium-containing molecular precursor and a zirconium-containing molecular precursor in an organic medium comprising an aliphatic monoalcohol such as n-propanol and, optionally, a diol solvent identical to that used in the preceding step; and
the mixing of said first and second solutions, optionally heating to reflux.

More precisely, according to this particular embodiment, the first solution is prepared by dissolving a lead-containing molecular precursor and a lanthanum-containing molecular precursor in a medium comprising a diol solvent (such as ethylene glycol), preferably all being heated in order to facilitate the dissolution. The molecular precursors, especially the lead-containing molecular precursor, may exist in hydrated form, in which case the heating may serve to distil off the water released in the reaction mixture when dissolving the abovementioned precursors. This is especially the case when the lead-containing molecular precursor used is lead acetate trihydrate.

In parallel, according to this embodiment, a second solution is prepared by dissolving a titanium-containing molecular precursor and a zirconium-containing molecular precursor in an organic medium comprising an aliphatic monoalcohol, such as n-propanol, and optionally a diol solvent such as that used for preparing the first solution.

Next, the first solution and the second solution, prepared separately, are mixed together so as to obtain a single homogeneous sol-gel solution. Preferably, this mixing step is facilitated by heating to reflux. Once the solution has a homogeneous appearance, the heating is stopped and the solution is cooled to room temperature.

This embodiment is particularly suitable when the molecular precursors are lead acetate trihydrate, lanthanum acetate, titanium isopropoxide and zirconium n-propoxide, respectively.

Once the sol-gel solution has been obtained after step a), whether by the method of implementation described above or by another method of implementation, the sol-gel solution is left to stand, according to the invention, for a suitable time until a solution having an approximately constant viscosity is obtained. In general, step b) is carried out at room temperature for a time ranging from one week to four months. During this maturing phase, the dissolved metal precursors (i.e. the precursors based on lead, titanium, zirconium and lanthanide metal) condense to an equilibrium state. This condensation is manifested by an increase in the viscosity of the sol-gel solution, until a value that is approximately constant as a function of time is reached, when the equilibrium state is reached. In practice, the solution prepared in step a) is left to stand generally at room temperature and in the absence of any heating. In parallel, the viscosity of the solution is measured at regular intervals. Once the viscosity is approximately constant, generally reached after a period ranging from one week to four months, the solution is diluted to a predetermined level of dilution (step c). This level of dilution will be chosen by a person skilled in the art according to the envisaged use of the sol-gel solution, and especially according to the desired thickness of material after such a solution has been deposited on a substrate and treated.

This dilution may consist in diluting the sol-gel solution obtained after step b) by a dilution factor ranging from 1 to 20.

According to the invention, the dilution solvent must be miscible with the diol solvent for preparing the solution of step a). It may be identical to the diol solvent for preparing the sol-gel solution of step a) or may be different and chosen, for example, from aliphatic monoalcohols, such as those defined above.

Preferably, the dilution solvent is a diol solvent identical to that used in step a).

The sol-gel solutions thus prepared may be used directly to form coatings or else, owing to their long-term stability, they may be used subsequently. These sol-gel solutions may therefore act as commercial solutions intended to be used subsequently, to be converted into an oxide ceramic material.

Thus, another subject of the invention is a sol-gel solution that can be obtained by a method as defined above.

The invention also relates to a method of preparing an oxide ceramic material comprising lead, titanium, zirconium and a lanthanide metal, said method comprising at least one cycle of steps including, in succession:
d) a step of depositing a layer of a sol-gel solution on a substrate, said sol-gel solution being obtained by the method described above; and
e) a step of heat treating said layer for the purpose of converting it into the oxide ceramic.

This manufacturing method has the advantage of being a reproducible method, that is to say always giving the same dielectric performance characteristics of films under the same conditions for producing the solution, and of being a repeatable method, that is to say reproducible over time thanks to the use of a stable sol-gel solution. The stable sol-gel solution resulting from the method described above, the physico-chemical characteristics (viscosity, state of condensation of the molecular species in solution, etc.) of which remain uniform as a function of time, guarantees reproducibility and repeatability of the thicknesses of materials deposited on the substrate and also their dielectric properties. Consequently, this method, which does not require the manufacturing parameters to be readjusted in order to guarantee a reproducible or repeatable result, is completely suitable for industrial manufacture.

Thus, the first step consists in depositing the stable sol-gel solution, prepared using the method described above, in the form of a layer on a substrate.

This layer may be deposited by any technique for obtaining a coating in the form of thin layers. The thicknesses of the thin layers deposited according to the invention may range from 1 to 500 nm.

The deposition may be carried out using one of the following techniques:
dip coating;
spin coating;
laminar-flow coating or meniscus coating;
spray coating;
soak coating;
roll coating or roll-to-roll coating;
brush coating or paint coating; and
screen printing.

However, the deposition will preferably be carried out by the technique of dip coating or else, the technique of spin coating. These techniques in particular make it easier to achieve precise control of the thicknesses of layers deposited.

As regards the technique of spin coating, the substrate intended to be coated is placed on a rotating support. Next, a volume of sol-gel solution allowing said substrate to be covered is deposited. The centrifugal force spreads said solution in the form of a thin layer. The thickness of the layer is in particular dependent on the centrifugation speed and on the concentration of the solution. Since the solution concentration parameter is fixed, a person skilled in the art may readily choose a centrifugation speed suitable for a desired layer thickness.

According to the invention, the substrate intended to be coated may be of various types, but it must preferably not contaminate the deposited layer, for example by migration of ions during the heat treatment, and must preferably allow the layer to adhere well. Its softening point must be advantageously above the temperature of the heat treatments carried out on the deposited layers, and its thermal expansion coefficient must advantageously be of the same order of magnitude as that of said layers, in order to limit stress effects during the annealing.

According to the invention, the substrate is preferably a silicon wafer optionally coated with a metal layer. This type of substrate advantageously exhibits good planarity and has an excellent surface finish, and in particular can be annealed at high temperature without being impaired.

This substrate may include a barrier layer on said face(s) serving as deposition face, this barrier layer having the function of preventing migration of atoms from the substrate into the deposited layer(s), obtained after heat treatment. This barrier layer also has the function of reducing the dielectric losses of materials obtained by the method of the invention. The barrier layer is deposited before step d) is implemented.

This barrier layer may be made of a material chosen from metal oxides of perovskite structure and in particular may be made of PbTiO₃ or SrTiO₃.

This barrier layer may have a thickness ranging from 1 to 100 nm, preferably less than 50 nm. To obtain such layers, it is possible to start with sol-gel solutions having a concentration between 2.5 and 20%, preferably between 2.5 and 10%, as mass equivalent of the metal oxide obtained.

Preferably, the barrier layer is made of PbTiO₃.

In the latter case, it may be prepared by a method comprising, in succession, the following steps:
deposition of at least one layer of a PbTiO₃ precursor sol-gel solution on said face(s) of the substrate; and
heat treatment of said layer for the purpose of converting said sol-gel solution into PbTiO₃.

This PbTiO₃ precursor sol-gel solution is prepared by the method comprising the following steps:
a sol-gel solution is prepared by bringing a lead-containing molecular precursor and a titanium-containing molecular precursor into contact with a medium comprising a diol solvent and optionally an aliphatic monoalcohol;
the solution obtained in the above step is left to stand for a sufficient time needed to obtain a solution having an approximately constant viscosity; and
the solution obtained by the above step is diluted to a predetermined level with a diol solvent identical to that of the first step (or the step of preparing the sol-gel solution) or a solvent miscible with the diol solvent used in the first step.

In particular, the sol-gel solution of the first step may be prepared by implementing a method comprising:
the preparation of a first solution by dissolving a lead-containing molecular precursor in an organic medium comprising a diol solvent;
the preparation of a second solution by dissolving a titanium-containing molecular precursor in an organic medium comprising an aliphatic monoalcohol and optionally a diol solvent identical to that used in the first step; and
the mixing of said first and second solutions, optionally heating to reflux.

The operating conditions (nature of the precursors, nature of the solvents, maturing time, etc.) for implementing the methods described above are identical to those already described in the case of the method of preparing a sol-gel solution as precursor of the oxide ceramic based on a lanthanide metal, lead, titanium and zirconium.

Likewise, the heat treatment necessary for ceramization of the barrier layer is identical to that described below for the ceramization of a layer of a sol-gel solution based on titanium, zirconium, lead and lanthanum.

Once the sol-gel solution as precursor of an oxide ceramic based on a lanthanide metal, titanium, zirconium and lead has been deposited on one face of the substrate, optionally covered with a barrier layer, the method of the invention includes a heat treatment carried out on the deposited layer(s) so as to convert them into the desired ceramic. This heat treatment may be carried out in various ways, whether the method of the invention comprises the implementation of one cycle of steps or of several cycles of steps as mentioned above.

Depending on the method of the invention, when the cycle of steps mentioned below is carried out only once, the heat treatment generally comprises, in succession, the following steps:
a step of drying the layer, generally at a temperature suitable for causing the latter to gel;
a calcination step, generally at a temperature suitable for eliminating the organic substances contained in the layer; and
an annealing step, generally at a temperature suitable for crystallizing the layer as an oxide ceramic.

Depending on the method of the invention, when the abovementioned cycle of steps is carried out n times, where n corresponds to the number of repetitions of the cycle, n being an integer that may range from 2 to 50, the heat treatment advantageously comprises:
for each of the (n−1) first layers deposited, a cycle of steps comprising, in succession:
   a step of drying each deposited layer,
   a step of calcining said layer and
   optionally, a step of preannealing said layer;
for the nth layer deposited, a cycle of steps comprising, in succession:
   a step of drying said layer,
   a step of calcining said layer and
   optionally, a step of preannealing said layer,
said heat treatment being completed with a step of annealing all said deposited layers (i.e. all n layers).

In other words, for the (n−1) first layers, each of said layers will undergo, in succession, a drying step and a calcination step, optionally followed by a preannealing step. Next, the nth layer deposited on the stack of (n−1) first layers will undergo, in succession, a drying step followed by a calcination step and advantageously a preannealing step. Finally, the heat treatment will be completed by a step of annealing the complete stack.

Whatever the alternative envisioned, each deposited layer of solution undergoes, according to the invention, a step consisting in drying the deposited layer so as to gel the layer. This step is intended to ensure that some of the diol-type solvent and some of the dilution solvent, and optionally by-products, such as esters, resulting from the reactions between the metal precursors, are evaporated. After this step, the sol-gel solution deposited is completely converted into a gel layer of constant thickness adhering to the surface of the substrate. The temperature and the duration of the drying that are effective for ensuring that gelling takes place may be readily determined by a person skilled in the art, for example using IR spectroscopy techniques.

For example, the drying step according to the invention may be carried out at a temperature below 100° C., for example at room temperature, for a time ranging from 1 to 10 minutes. In other words, this deposition step will consist in letting the layer stand, just after being deposited, so that it dries.

After drying, each layer undergoes a calcination step carried out at a temperature and for a time suitable for completely eliminating the organic compounds of the deposited layer and in particular the solvents for preparing and diluting the sol-gel solution, and the compounds generated by the reaction between the molecular precursors. The effective temperature and duration may be determined readily by a person skilled in the art, by using techniques such as IR (infrared) spectroscopy.

The duration of the calcination for a given temperature corresponds to a duration for obtaining a constant layer thickness. The layer thickness is for example controlled by profilometry techniques. The calcination step is stopped upon obtaining a layer of uniform thickness free of organic compounds.

Preferably, this calcination step is carried out at a temperature ranging from 300 to 380° C. for a time ranging from around 30 seconds to around 20 minutes.

Advantageously, when the method comprises the deposition of several layers, the (n−1) first layers deposited may be made to undergo a preannealing step, consisting in heating them to a temperature above 380° C. and ranging up to 450° C., preferably between 385 and 405° C., for a time ranging from 1 minute to 60 minutes, preferably for a time of longer than 15 minutes, for example longer than 20 minutes.

Preferably, this preannealing step is carried out only on the last layer (the nth layer) (or in other words on the stack of n layers deposited) under operating conditions (temperature, time) identical to those described in the above paragraph.

This preannealing step makes it possible to improve the dielectric performance characteristics of the layers, in so far as this step prevents the formation of a pyrochlore phase unfavorable for dielectric properties. In addition, this preannealing step under the aforementioned operating conditions allows some of the stresses that have built up in the layers during the treatments prior to this step to be relaxed and enables the carbon impurities still remaining after the calcination step to be eliminated. This step also allows said layers to be stabilized.

Finally, after the optional preannealing step, the heat treatment comprises an annealing step carried out for a time and at a temperature that are effective for crystallizing the deposited layer or all of the deposited layers. The crystallization of the layer corresponds to obtaining a layer of stabilized thickness and of crystallized structure of the perovskite type. The temperature and the duration of the annealing are chosen so as to achieve this crystallization, which can be readily verified by structural analysis, such as X-ray diffraction analysis. Preferably, the annealing is carried out at a temperature ranging from about 500° C. to about 800° C. for a time ranging between about 30 seconds and about one hour. When the method comprises the deposition of several layers, the annealing step is advantageously carried out on the complete stack of layers, each of the (n−1) first layers of the stack having undergone beforehand a drying step, a calcination step and a preannealing step.

The annealing may be carried out by various techniques. Preferably, the annealing is carried out by rapid heating obtained, for example, by the RTA (Rapid Thermal Annealing) technique or the RTP (Rapid Thermal Process) technique.

The sol-gel solution deposition step and the heat treatment step may be repeated one or more times, until a material having the desired thickness is obtained.

According to the invention, the film formed by depositing at least one layer makes it possible, after the heat treatment of the method, to obtain a film of an oxide ceramic comprising a lanthanide metal, lead, titanium and zirconium, crystallized in a unique system corresponding to the perovskite system, with a slight preferential orientation corresponding to the [111] direction of the substrate. No pyrochlore phase was detected with the method of the invention.

Finally, the invention relates to a material made of an oxide ceramic comprising lead, titanium, zirconium and a lanthanide metal that can be obtained by a method as defined above.

The invention will now be described with reference to the following examples given by way of nonlimiting illustration.

### DETAILED DESCRIPTION OF PARTICULAR EMBODIMENTS

### Example 1

### Preparation of a Stable Sol-Gel Solution of 9/52/48 Composition, i.e. Pb_{1.01}La_{0.09}Zr_{0.52}Ti_{0.48}O_{3.145}

This example of a method of preparation comprises several steps:
a step of preparing a first sol-gel solution based on lead and lanthanum (section a) below);
a step of preparing a second sol-gel solution, based on titanium and zirconium (section b) below); and
a step of mixing said first solution with said second solution (section c) below).

### a) Preparation of the First Sol-Gel Solution, Based on Lead and Lanthanum.

In this example, the lead-containing and lanthanum-containing molecular precursors were lead acetate and lanthanum acetate respectively.

Weighed into a three-necked flask, fitted on top with a distillation arrangement, were 208.6 g (0.55 mol) of lead acetate trihydrate, 15.8 g (0.045 mol) of lanthanum acetate containing 10% water by weight, and 260 g (5.32 mol) of ethylene glycol. The mixture was homogenized for 30 minutes at 70° C. so as to allow the lead acetate to be completely dissolved, and then for 15 minutes at 105° C. to dissolve the lanthanum acetate. The temperature of the homogeneous solution obtained was then increased in order to dehydrate the lead and lanthanum precursors by distillation (vapor temperature around 100° C.). During the distillation, yellowing of the solution was observed. 30 g of distillate were collected and the Pb concentration of the lead alkoxide solution was around 1.21 mol/kg.

### b) Preparation of the Second Solution, Based on Titanium and Zirconium

Under argon flushing, 68.22 g (0.24 mol) of titanium isopropoxide were added, with stirring, to 80 g (100 ml) of 1-propanol, and 121.67 g (0.26 mol) of 70% zirconium propoxide in 1-propanol and ethylene glycol (140 g) were added. The mixture was stirred for 10 minutes at room temperature.

### c) Mixing of the First and Second Solutions

The solution prepared in b) was rapidly added, with vigorous stirring (600 rpm), under a stream of argon, into the three-necked flask containing the precursor solution based on lead and lanthanum prepared beforehand and heated to 60° C. The lead alkoxide was in a 10% excess in order to mitigate the loss of lead oxide (PbO) during the heat treatment of the films. After the addition, a condenser surmounted by a drying tube was fitted and the argon flushing was stopped. The solution was heated to reflux (104° C.) over 2 hours. During the temperature rise, the stirring rate was reduced to 250 rpm. After reflux, a solution was obtained that had a concentration of around 26% as PLZT mass equivalent. Next, the solution was maintained at room temperature, without stirring, for one week of maturing. The solution was then diluted to 20% as PLZT mass equivalent (i.e. 0.67M) by adding the appropriate amount of ethylene glycol.

### Example 2

### Preparation of a Stable Sol-Gel Solution of 9/65/35 Composition, i.e. Pb_{1.01}La_{0.09}Zr_{0.65}Ti_{0.35}O_{3.145}

This example of a method of preparation comprises several steps:
a step of preparing a first sol-gel solution based on lead and lanthanum (section a) below);
a step of preparing a second sol-gel solution, based on titanium and zirconium (section b) below); and
a step of mixing said first solution with said second solution (section c) below).

### a) Preparation of the First Sol-Gel Solution, Based on Lead and Lanthanum.

The lead-containing and lanthanum-containing molecular precursors were lead acetate and lanthanum acetate respectively.

Weighed into a three-necked flask, fitted on top with a distillation arrangement, were 208.6 g (0.55 mol) of lead acetate trihydrate, 15.8 g (0.045 mol) of lanthanum acetate containing 10% water by weight, and 260 g (5.32 mol) of ethylene glycol. The mixture was homogenized for 30 minutes at 70° C. so as to allow the lead acetate to be completely dissolved, and then for 15 minutes at 105° C. to dissolve the lanthanum acetate. The temperature of the homogeneous solution obtained was then increased in order to dehydrate the lead and lanthanum precursors by distillation (vapor temperature around 100° C.). During the distillation, yellowing of the solution was observed. 30 g of distillate were collected and the Pb concentration of the lead alkoxide solution was around 1.21 mol/kg.

### b) Preparation of the Second Solution, Based on Titanium and Zirconium

Under argon flushing, 49.75 g (0.175 mol) of titanium isopropoxide were added, with stirring, to 80 g (100 ml) of 1-propanol, and 152.1 g (0.325 mol) of 70% zirconium n-propoxide in 1-propanol were added. The mixture was stirred at room temperature.

### c) Mixing of the First and Second Solutions

The second solution prepared in b) was rapidly added, with vigorous stirring (600 rpm), under a stream of argon, into the three-necked flask containing the precursor first solution based on lead and lanthanum prepared beforehand and heated to 60° C. The lead alkoxide was in a 10% excess in order to mitigate the loss of lead oxide (PbO) during the heat treatment of the films. After the addition, a condenser surmounted by a drying tube was fitted and the argon flushing was stopped. The solution was heated to reflux (104° C.) over 2 hours. During the temperature rise, the stirring rate was reduced to 250 rpm. After reflux, a solution was obtained that had a concentration of around 26% as PLZT mass equivalent. Next, the solution was maintained at room temperature, without stirring, for one week. The solution was then diluted to 20% as PLZT mass equivalent (i.e. 0.67M) by adding the appropriate amount of ethylene glycol.

### Example 3

### Preparation of a PbTiO₃ Precursor Sol-Gel Solution

This example illustrates the preparation of a PbTiO₃ precursor sol-gel solution serving, within the context of the invention, for the preparation of barrier layers between the deposition substrate and the oxide ceramic based on lanthanum, lead, titanium and zirconium.

Weighed into a three-necked flask, fitted on top with a distillation arrangement, were 139.1 g (0.37 mol) of lead acetate trihydrate and 60 g (0.97 mol) of ethylene glycol. The mixture was homogenized for 30 minutes at 70° C. so as to completely dissolve the lead acetate. The temperature of the homogeneous solution obtained was then increased in order to dehydrate the lead acetate (temperature around 100° C.). During the distillation, yellowing of the solution was observed. 21 g of distillate were collected and the lead concentration of the lead alkoxide solution was around 2.08 mol/kg.

Under argon flushing, 94.75 g (0.33 mol) of titanium isopropoxide and 100 g (1.61 mol) of ethylene glycol were added, with stirring, into 160 g of 1-propanol. The mixture was stirred for 15 minutes at room temperature.

The titanium solution was rapidly added, with vigorous stirring (300 rpm), under a stream of argon, to the three-necked flask containing the lead-based precursor solution prepared beforehand and heated to 60° C. The lead alkoxide was in 10% excess in order to mitigate the loss of lead oxide during heat treatment of the solution deposited in layer form. After the end of the addition, a condenser surmounted by a drying tube was fitted and the argon flushing was stopped. The solution was heated to reflux (100° C.) over 15 minutes. After reflux, a solution with a concentration of around 21% in mass equivalent of lead oxide and titanium oxide was obtained. The solution was then maintained at room temperature, without stirring, for 24 hours, after which time it had a viscosity that no longer varied. After this time, the solution was diluted to a concentration ranging from 5 to 10%.

### Example 4

### Preparation of Films Made of Oxide Ceramic Based on Lanthanum, Lead, Titanium and Zirconium

This example illustrates the preparation of a ceramic film by depositing three layers of sol-gel solutions prepared beforehand, according to the examples described above (Examples 1 and 2) on a substrate. The substrate chosen was a [111] oriented silicon wafer with a diameter of 12.5 to 15 cm, said wafer being metallized by sputtering with a platinum layer having a thickness ranging from 100 nm to 200 nm, serving as lower electrode. The deposition technique used in this example was spin coating, making it possible to adjust, for a solution of given concentration, the deposited thickness by choosing the rotation speed suitable for the device. The coatings were deposited in a zone with controlled dusting so as to limit the presence of particulate inclusions in the films and in a controlled environment (controlled temperature and humidity) so as to guarantee the reproducibility of the evaporation conditions.

The sol-gel solution diluted to 20% by weight was filtered on a 0.2 μm filter prior to deposition on the wafer. The rotation speed, for carrying out the deposition, was adjusted to 4500 rpm so as to obtain a final thickness per individual deposited layer, ranging from 50 to 70 nm.

The deposited layer was then gelled by drying for 2 minutes at 50° C. After the deposited layer was dried and heated, it was subjected to a calcination at a temperature of 360° C. for 2 minutes.

In this example, the operation of depositing the layer followed by the abovementioned treatment (drying and calcination) was carried out three times.

Finally, the three-layer stack obtained was subjected to a preannealing treatment by heating at 390° C. for 20 minutes in an air atmosphere followed by an annealing step at a temperature of 700° C. for 5 minutes.

This example was repeated twice with the solution prepared in Example 1. The films obtained, called respectively film 1 and film 2, had the following characteristics:

| | | Capacitance | Dielectric |
|---|---|---|---|
| | Thickness of | (nF/mm²) at | constant at |
| Film | the film | 0 V/10 kHz | 0 V/10 kHz |
| 1 | 170 nm | 48 | 921 |
| 2 | 207 nm | 40.5 | 947 |

This example was also repeated twice with the solution prepared as explained in Example 2. The films obtained, called film 3 and film 4 respectively, had the following characteristics:

| | | Capacitance | Dielectric |
|---|---|---|---|
| | Thickness of | (nF/mm²) at | constant at |
| Film | the film | 0 V/10 kHz | 0 V/10 kHz |
| 3 | 175 nm | 41 | 810 |
| 4 | 160 nm | 45 | 810 |

### Example 5

This example illustrates the preparation of a film of a ceramic of formula Pb_{1.01}La_{0.09}Zr_{0.65}Ti_{0.35}O_{3.145} by depositing three layers of sol-gel solutions prepared beforehand according to Example 2 on a substrate, this deposition no longer being carried out in direct contact with the substrate but in contact with a PbTiO₃ barrier layer deposited beforehand.

This barrier layer was produced by depositing a layer of sol-gel solution as prepared in Example 3 by spin coating (at 4500 rpm) followed by a heat treatment, comprising drying the layer at 50° C. and calcination at 360° C.

Once the barrier layer has been deposited, the film is deposited in accordance with-what was explained above in Example 4.

The film obtained, called film 5, had the following characteristics:

| | | | | Dielectric |
|---|---|---|---|---|
| | Thickness | Capacitance | | constant |
| | of the | (nF/mm²) at | Dielectric | at |
| Film | film | 0 V/10 kHz | loss | 0 V/10 kHz |
| 5 | 180 nm | 39 | 6% | 793 |

Compared with film 3, which had a dielectric loss of around 9%, film 5 had a lower dielectric loss and substantially the same capacitance.

This demonstrates that the presence of a barrier layer makes it possible to reduce the dielectric losses of the deposited film without its capacitance deteriorating.

1-35. (canceled)

36. A method of preparing a stable sol-gel solution as precursor of an oxide ceramic based on lead, titanium, zirconium and a lanthanide metal, the method comprising in succession the following steps:
a) preparing a sol-gel solution by bringing a lead-containing molecular precursor, a titanium-containing molecular precursor, a zirconium-containing molecular precursor and a lanthanide-metal-containing molecular precursor into contact with a medium comprising a diol solvent and optionally an aliphatic monoalcohol;
b) leaving the sol-gel solution obtained in step a) to stand for a sufficient time needed to obtain a solution having an approximately constant viscosity; and
c) diluting the sol-gel solution obtained in step b) to a predetermined amount with a diol solvent identical to that of step a) or a solvent miscible with the diol solvent used in step a).

37. The method as claimed in claim 36, wherein the lead-containing molecular precursor is chosen from inorganic lead salts and organometallic lead compounds.

38. The method as claimed in claim 37, wherein the inorganic lead salt is chosen from lead chloride and lead nitrate.

39. The method as claimed in claim 37, wherein the organometallic lead compound is chosen from lead acetate and lead alkoxides.

40. The method as claimed in claim 36, wherein the lanthanide-metal-containing molecular precursor is a lanthanum-containing molecular precursor.

41. The method as claimed in claim 40, wherein the lanthanum-containing molecular precursor is an organometallic lanthanum compound.

42. The method as claimed in claim 41, wherein the organometallic lanthanum compound is lanthanum acetate.

43. The method as claimed in claim 42, wherein the lanthanum-containing molecular precursor is an inorganic lanthanum salt.

44. The method as claimed in claim 43, wherein the inorganic lanthanum salt is chosen from lanthanum nitrate and lanthanum chloride.

45. The method as claimed in claim 36, wherein the titanium-containing molecular precursor is an organometallic titanium compound.

46. The method as claimed in claim 45, wherein the organometallic titanium compound is a titanium alkoxide.

47. The method as claimed in claim 36, wherein the zirconium-containing molecular precursor is an organometallic zirconium compound.

48. The method as claimed in claim 47, wherein the organometallic zirconium compound is a zirconium alkoxide.

49. The method as claimed in claim 36, wherein the diol solvent used in step a) and optionally step c) is an alkylene glycol having a number of carbon atoms ranging from 2 to 5.

50. The method as claimed in claim 49, wherein the diol solvent is ethylene glycol.

51. The method as claimed in claim 36, wherein the aliphatic monoalcohol contains 1 to 6 carbon atoms.

52. The method as claimed in claim 36, wherein, when the lanthanide metal is lanthanum, step a) comprises:
preparing a first solution by dissolving a lead-containing molecular precursor and a lanthanum-containing molecular precursor in an organic medium comprising a diol solvent;
preparing a second solution by dissolving a titanium-containing molecular precursor and a zirconium-containing molecular precursor in an organic medium comprising an aliphatic monoalcohol and, optionally, the diol solvent; and
mixing said first and second solutions, optionally heating to reflux.

53. The method as claimed in claim 36, wherein step b) is carried out at room temperature for a time ranging from one week to four months.

54. The method as claimed in claim 36, wherein the solvent used in step c) is an aliphatic monoalcohol.

55. A sol-gel solution obtained by a method of preparation as defined in claim 36.

56. A method of preparing an oxide ceramic material comprising lead, titanium, zirconium and a lanthanide metal, the method comprising at least one cycle of steps including, in succession:
a) depositing a layer of a sol-gel solution on at least one of the faces of a substrate, said sol-gel solution being obtained by the method comprising:
i) preparing a sol-gel solution by bringing a lead-containing molecular precursor, a titanium-containing molecular precursor, a zirconium-containing molecular precursor and a lanthanide-metal-containing molecular precursor into contact with a medium comprising a diol solvent and optionally an aliphatic monoalcohol;
ii) leaving the sol-gel solution obtained in step i) to stand for a sufficient time needed to obtain a solution having an approximately constant viscosity; and
iii) diluting the sol-gel solution obtained in step ii) to a predetermined amount with a diol solvent identical to that of step i) or a solvent miscible with the diol solvent used in step i); and
b) heat treating said layer and converting said layer into the oxide ceramic.

57. The method of preparation as claimed in claim 56, wherein deposition step a) is carried out by dip coating.

58. The method of preparation as claimed in claim 56, wherein deposition step a) is carried out by spin coating.

59. The method of preparation as claimed in claim 56, wherein the substrate is a silicon wafer.

60. The method of preparation as claimed in claim 56, wherein said face or faces of the substrate are covered, prior to step a), with a barrier layer comprising a metal oxide of perovskite structure.

61. The method of preparation as claimed in claim 60, wherein the barrier layer is made of PbTiO₃ or SrTiO₃.

62. The method of preparation as claimed in claim 61, wherein the barrier layer is made of PbTiO₃.

63. The method of preparation as claimed in claim 62, wherein the barrier layer is prepared by a method comprising, in succession, the following steps:
depositing at least one layer of a PbTiO₃ precursor sol-gel solution on said face(s) of the substrate; and
heat treating said layer to convert said sol-gel solution into PbTiO₃.

64. The method of preparation as claimed in claim 63, wherein the PbTiO₃ precursor sol-gel solution is prepared by a method comprising the following steps:
preparing a PbTiO₃ precursor sol-gel solution by bringing a lead-containing molecular precursor and a titanium-containing molecular precursor into contact with a medium comprising a diol solvent and optionally an aliphatic monoalcohol;
leaving the PbTiO₃ precursor sol-gel solution to stand for a time sufficient to obtain an approximately constant viscosity; and
diluting the PbTiO₃ precursor sol-gel solution having an approximately constant viscosity to a predetermined level with the diol solvent or a solvent miscible with the diol solvent.

65. The method of preparation as claimed in claim 56, wherein, when the cycle of steps as defined in claim 56 is carried out only once, the heat treating comprises, in succession, a step of drying the layer deposited in step a) and a step of calcining said layer deposited in step a), followed by a step of annealing said layer deposited in step a).

66. The method of preparation as claimed in claim 56, wherein, when the cycle of steps as defined in claim 56 is carried out n times, n corresponding to the number of repetitions of the cycle, the heat treatment comprises:
for each of the (n−1) layers deposited, a cycle of steps comprising, in succession:
drying the (n−1) deposited layer,
calcining the (n−1) deposited layer; and
optionally, preannealing the (n−1) deposited layer;
for the nth layer deposited, a cycle of steps comprising, in succession:
drying said nth layer,
calcining said nth layer and
optionally, preannealing said nth layer; and
annealing all said n deposited layers.

67. The method of preparation as claimed in claim 65, wherein the drying step consists of letting the layer deposited stand at a temperature below 100° C. for a time ranging from 1 minute to 10 minutes after deposition.

68. The method of preparation as claimed in claim 65, wherein the calcination step is carried out at a temperature ranging from 300 to 380° C. for a time ranging from 30 seconds to 20 minutes.

69. The method of preparation as claimed in claim 65, wherein the annealing step is carried out at a temperature ranging from 500 to 800° C. for a time ranging from 30 seconds to 1 hour.

70. The method of preparation as claimed in claim 66, wherein the drying step consists of letting the (n−1) and nth layer deposited stand at a temperature below 100° C. for a time ranging from 1 minute to 10 minutes after deposition.

71. The method of preparation as claimed in claim 66, wherein the calcination step is carried out at a temperature ranging from 300 to 380° C. for a time ranging from 30 seconds to 20 minutes.

72. The method of preparation as claimed in claim 66, wherein the annealing step is carried out at a temperature ranging from 500 to 800° C. for a time ranging from 30 seconds to 1 hour.

73. The method of preparation as claimed in claim 66, wherein the preannealing step is carried out at a temperature above 380° C. and ranging up to 450° C., for a time ranging from 1 minute to 60 minutes.

74. The method of preparation as claimed in claim 66, wherein the preannealing step is carried out at a temperature between 385 and 405° C., for a time ranging from 1 minute to 60 minutes.
